(19) United States
(12) Patent Application Publication
(10) Pub. No.: US 2014/0182297 A1
(43) Pub. Date: Jul. 3, 2014

(54) GAS TURBINE AND METHOD OF CONTROLLING A GAS TURBINE AT PART-LOAD CONDITION

(71) Applicant: GENERAL ELECTRIC COMPANY, Schenectady, NY (US)

(72) Inventors: Jason Charles Terry, Greenville, SC (US); Timothy Andrew Healy, Simpsonville, SC (US); Mark William Pinson, Greer, SC (US); Gregory Earl Jensen, Greenville, SC (US)

(73) Assignee: GENERAL ELECTRIC COMPANY, Schenectady, NY (US)

(21) Appl. No.: 13/733,313

(22) Filed: Jan. 3, 2013

(51) Int. Cl. F02C 9/00

(52) U.S. Cl. CPC F02C 9/00
USPC 60/773; 60/793

(57) ABSTRACT

A gas turbine includes a compressor section, a combustion section downstream from the compressor section, a turbine section downstream from the combustion section, and a controller. The controller controls the operation of the gas turbine at a reduced load, and is capable of querying a database including multiple sets of operational parameters for the gas turbine correlated with at least one measured output response at each set of operational parameters. One of the sets of operational parameters provides a desired gas turbine load that meets a target level for the output response. Related methods are also disclosed.

### FIELD OF THE INVENTION

The subject matter disclosed herein relates to control of gas turbines at part-load conditions.

### BACKGROUND OF THE INVENTION

In some heavy-duty gas turbines, premixed dry low NOx (DLN) combustion systems are used. In such turbines, fuel staging, air staging, or a combination of the two, can enable operation across a wide range of conditions. However, the parameters in which premixed combustion can be used are relatively narrow when compared to the duty cycle of a modern gas turbine. Therefore, conditions within the combustion system are staged to create local zones of stable combustion despite the fact that bulk conditions would place the design outside its operational limits (i.e., emissions, flammability, etc.).

When coupled with automatic and continuous feedback, the fuel staging of a DLN system can be manipulated in real time to automatically adjust the response of the combustion system to respond to duty cycle changes via, but not limited to, gas turbine loading changes and ambient temperature variation. This methodology has been successfully demonstrated to maximize base-load performance while respecting NOx, combustion instability, and lean blowout boundaries.

Increasingly, the heavy-duty as turbine market has demanded that part-load operation be optimized as well to allow a customer to reduce the gas turbine load to a desired level (i.e. turndown operation) while still keeping the gas turbine in emissions compliance. Typically, the limiting factor in a reduced gas turbine load situation is CO emissions due to the highly non-linear response to temperature variations. CO is also known to have a non-trivial response to local flame conditions inside the combustor, i.e. fuel staging mentioned above. Also, seasonal ambient temperature variations can cause performance issues with part-load operation that require re-tuning combustion parameters to maintain emissions compliance.

Accordingly, a control system and method to address one or more of the above drawbacks or others so as to manage operation of a DLN combustion gas turbine at part-load and/or turndown conditions would be welcome.

### BRIEF DESCRIPTION OF THE INVENTION

Aspects and advantages of the invention will be set forth in part in the following description, or may be obvious from the description, or may be learned through practice of the invention.

According to certain aspects of the disclosure, a method of operating a gas turbine at a reduced load includes, for example, the steps of operating a gas turbine at multiple sets of operational parameters; measuring at least one output response of the gas turbine at each of the sets of operational parameters; creating a database at least partially including correlations of each of the sets of operational parameters with the measured output response; determining a desired reduced gas turbine load; selecting a set of operational parameters from the database that provides the desired reduced gas turbine load and that meets a target level for the output response; and further operating the gas turbine at the selected set of operational parameters. Various options and modifications are possible.

According to certain other aspects of the disclosure, a method of operating a gas turbine at a reduced load includes, for example, the steps of determining a desired reduced gas turbine load; consulting a database including multiple sets of operational parameters correlated with at least one measured output response at each set of operational parameters; selecting a set of operational parameters from the database that provides the desired reduced gas turbine load and that meets a target level for the output response; and operating the gas turbine at the selected set of operational parameters. As above, various options and modifications are possible.

According to still other aspects of the disclosure, a gas turbine includes, for example, a compressor section, a combustion section downstream from the compressor section, a turbine section downstream from the combustion section, and a controller. The controller controls the operation of the gas turbine at a reduced load, and is capable of querying a database including multiple sets of operational parameters for the gas turbine correlated with at least one measured output response at each set of operational parameters. One of the sets of operational parameters provides a desired gas turbine output and corresponds to the lowest gas turbine load that meets a target level for the output response. Various options and modifications are possible.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic depiction of a gas turbine useful in the disclosed methods and systems;

FIG. 2 is a flowchart outlining steps performed by the disclosed methods and systems; and

FIG. 3 is a chart showing correlated sets of operational parameters and output responses according to certain aspects of the present disclosed methods and systems.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

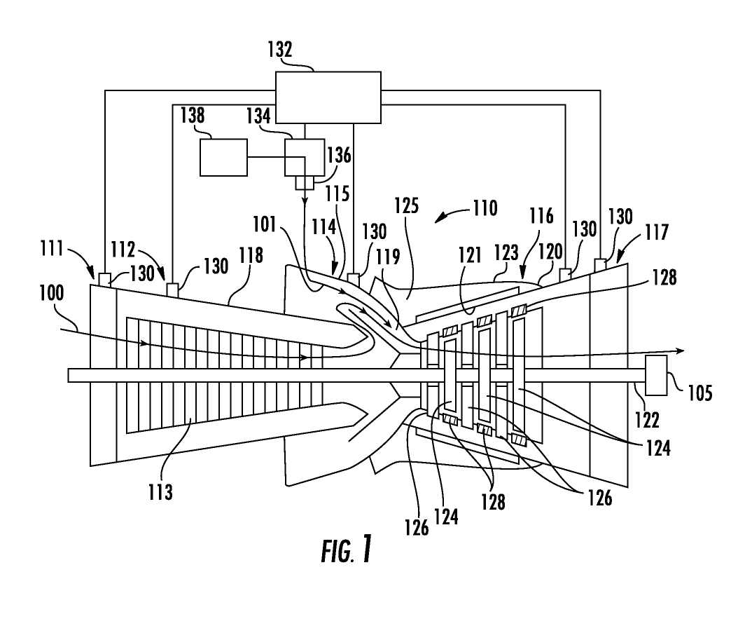

FIG. 1 is a schematic view of an exemplary gas turbine that can incorporate the systems and methods of the present disclosure. As illustrated, gas turbine 110 includes an inlet section 111, a compressor section 112, a combustion section 114, a turbine section 116, and an exhaust section 117. A shaft (rotor) 122 may be common to compressor section 112 and turbine section 116 and may further connect to a generator 105 for generating electricity. Inlet section 111 may have inlet guide vanes (IGV) for controlling flow, as desired.

The compressor section 112 may include an axial flow compressor in which a working fluid 100, such as ambient air, enters the compressor from the inlet section 111 and passes through alternating stages 113 of stationary vanes and rotating blades (shown schematically in FIG. 1). Compressor casing 118 contains the working fluid 100 as the stationary vanes and rotating blades accelerate and redirect the working fluid to produce a continuous flow of compressed working fluid. The majority of the compressed working fluid flows downstream through the combustion section 114 and then the turbine section 116.

The combustion section 114 may include any type of combustor known in the art. A combustor casing 115 may circumferentially surround some or all of the combustion section 114 to direct the compressed working fluid 100 from the compressor section 112 to a combustion chamber 119. Fuel 101 is also supplied to the combustion chamber 119. Possible fuels include, for example, one or more of blast furnace gas, coke oven gas, natural gas, vaporized liquefied natural gas (LNG), hydrogen, and propane. The compressed working fluid 100 mixes with fuel 101 in the combustion chamber 119 where it ignites to generate combustion gases having a high temperature and pressure. The combustion gases then enter the turbine section 116.

Within turbine section 116, alternating stages of rotating blades (buckets) 124 and stationary blades (nozzles) 126 are attached to rotor 122 and turbine casing 120, respectively. Working fluid 100, such as steam, combustion gases, or air, flows along a hot gas path through gas turbine 110 from left to right as shown in FIG. 1. The first stage of stationary nozzles 126 accelerates and directs the working fluid 100 onto the first stage of rotating blades 124, causing the first stage of rotating blades 124 and rotor 122 to rotate. Working fluid 100 then flows across the second stage of stationary nozzles 126 which accelerates and redirects the working fluid to the next stage of rotating blades (not shown), and the process repeats for each subsequent stage.

Radially inward portion of turbine casing 120 may include a series of shroud segments 128 connected to the turbine casing that circumferentially surround and define the hot gas path to reduce the amount of working fluid 100 that bypasses the stationary nozzles 126 or rotating buckets 124. Exhaust gases leave gas turbine 110 via exhaust housing 117 and may be used in a secondary steam turbine cycle (not shown).

The operation of the gas turbine may be monitored by several sensors 130 in communication with a turbine controller 132 for detecting various conditions of the turbine, generator and environment. For example, temperature sensors may monitor compressor discharge temperature, turbine exhaust gas temperature, and other temperature measurements of the gas stream through the gas turbine. Pressure sensors may monitor static and dynamic pressure levels at the compressor inlet and outlet, and turbine exhaust, as well as at other locations in the gas stream. Sensors 130 may also comprise flow sensors, speed sensors, flame detector sensors, valve position sensors, guide vane angle sensors, or the like that sense various parameters pertinent to the operation of gas turbine 110. Sensors 130 may also detect levels of emissions such as NOx or CO, lean blow out, or combustor instability boundaries.

Controller 132 may incorporate a General Electric SPEEDTRONIC™ Gas Turbine Control System, such as is described in Rowen, W. I., “SPEEDTRONIC™ Mark V Gas Turbine Control System”, GE-3658D, published by GE Industrial & Power Systems of Schenectady, N.Y. Controller 132 may also incorporate a computer system having a processor(s) that executes programs stored in a memory to control the operation of the gas turbine using sensor inputs and instructions from human operators. The programs executed by controller 132 may include scheduling algorithms for regulating fuel flow to combustion section 114 and the angle of the inlet guide vanes (IGV's). The commands generated by controller 130 may, for example, cause a fuel controller 134 of gas turbine 110 to adjust valves 136 between the fuel supply 138 and combustion section 114 to regulate the flow and type of fuel, of may cause actuators 140 to adjust the angle of the IGV's of inlet section 111.

Controller 130 regulates gas turbine 110 based, at least in part, on a database stored in the memory of the controller. This database enables controller 130 to maintain the NOx and CO emissions in the turbine exhaust to within certain predefined limits, to maintain the combustor within suitable stability boundaries and to avoid lean blow out scenarios. If combustion section 114 is a DLN combustion system, controller 130 may be programmed to control the DLN combustion system.

Controller 130 may set operational parameters such as the gas turbine load, the inlet guide vane angle, inlet bleed heat, combustor fuel split, and control curve so as to: 1) achieve the desired gas turbine load such as generator output or heat-rate output; while 2) staying within desired boundaries of certain other output responses, such as a level of one or more of: emissions, lean blowout, and combustor instability measurements.

As used herein, “gas turbine load” means the power output of a gas turbine's generator(s); “inlet guide vane angle” means the angles of the vanes relative to axial flow through the inlet section upstream from the compressor section; “inlet bleed heat” means the amount of heat in fluid extracted from a downstream portion of the compressor section and inserted in an upstream portion of the compressor section to heat the flow therein; “fuel split” means the amount of fuel sent to different circuits within the combustor section; “control curve” means empirically determined curves used to control various functions of a gas turbine; “emissions” means levels of various exhaust gases; “lean blowout” means conditions wherein combustor mix is lean enough to experience incomplete burn; and “combustor instability” means level of pressure fluctuations within a combustion section.

When operating gas turbine 110 in a reduced load condition, which can be a turndown to a predetermined desired output load or a turndown to a minimal load possible for the gas turbine, it can be more challenging to stay within the boundaries of the output responses noted above. Accordingly, methods and control systems according to the present disclosure can be employed.

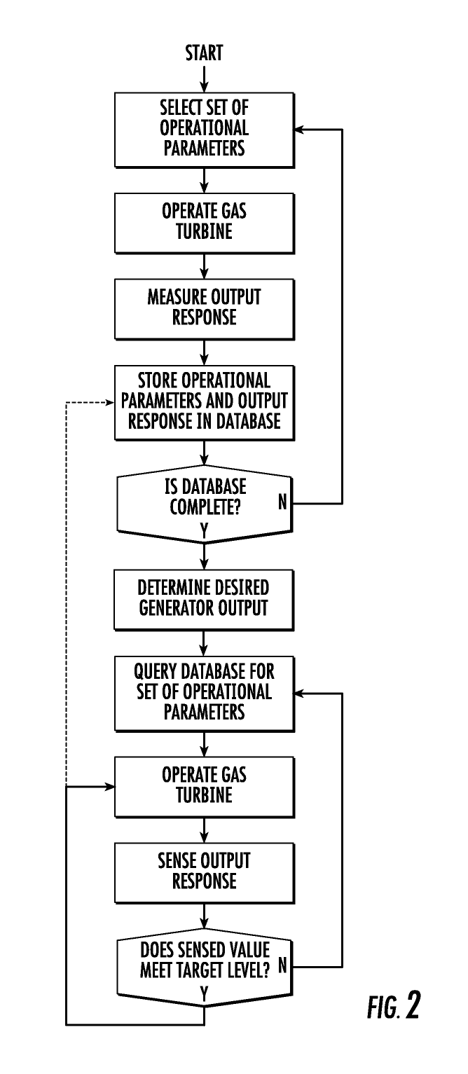

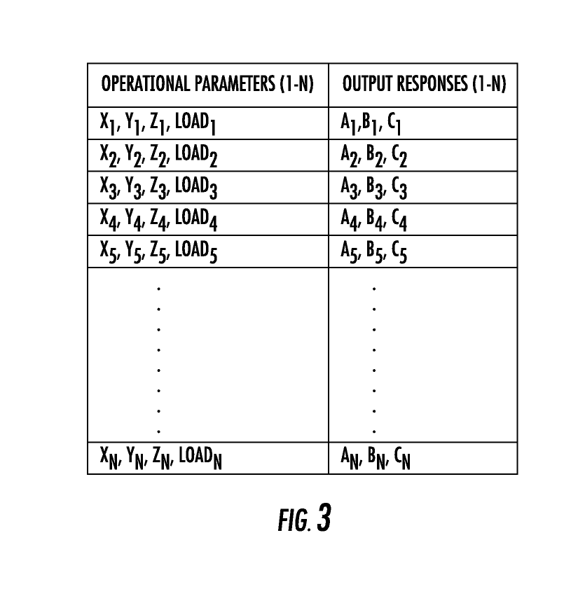

For example, according to at least a part of the method set forth in the flowchart in FIG. 2, one can select a set of operational parameters (X₁, Y₁, Z₁, Load', etc.) and measure at least one output response (A₁, B₁, C₁, etc.) of gas turbine 110 when operated according to those parameters. Such output responses can be measured while noting operational parameters such as, for example, gas turbine load, inlet guide vane angle, inlet bleed heat, combustor fuel splits, and control curve. A database can be created from the output responses correlating the operational parameters and output responses. The database may also include, partial derivatives relating the operational parameters to the output responses, if such information is desired. These steps may be performed as many times as is required until a database is created having sufficient sets of operational parameters to control the gas turbine in a desired range of performance characteristics. Alternatively, the correlated data can be created partially or wholly from computational modeling of gas turbine performance. The database of correlated values from 1 to N can be stored in a memory within controller 130, as shown in FIG. 3.

Returning to FIG. 2, once the database is created, for a desired reduced load (a stated generator output or heat rate; or a minimal generator output), operational parameters can be selected from the database to find the set of operational parameters having the desired or lowest gas turbine load that still meets a target level for one or more of the output responses. The correlated information within the database can be sifted to determine one or more sets of suitable operational parameters that can stay within the required output response boundaries while providing the required reduced (predetermined or minimum) load.

If desired, to if several sets of parameters are found that meet the requirements, a determination can be made by evaluating the output responses which set is the best in a given situation or installation. Such evaluation can be made based on an evaluation of the level of one, multiple or all output responses. If more than one response is to be considered, such evaluation can be done in numerous ways, such as via scaling of each output response against corresponding others in other sets, weighting the output responses or scaled responses, etc. Algorithms can be created as desired to evaluate the sets to determine a best set. Alternatively, the set that uses the least fuel, is most efficient, and/or that achieves the lowest desired load can be selected. Accordingly, numerous different criteria can be used to select from suitable sets of operational parameters.

The validity of the information in the database with reference to a given gas turbine installation or operational instance can be evaluated upon operation of the gas turbine at the selected operational parameters. For example, while the gas turbine is operated utilizing the selected operational parameters the output responses can be measured. The measured output responses can be compared to the target levels for the output responses to determine, for example, if NOx or CO emissions are above desired levels. If the output responses meet the target level, then the gas turbine operation continues using the parameters set by controller 130. If not, an alternate set of operational parameters can be selected, and the process of running the gas turbine and monitoring the output responses can be repeated until the output responses meet the target levels. Continuous or periodic sensor feedback can be used to determine if gas turbine output response is continuing to meet the target levels. If the initial comparison or a later comparison determines that the output response does not meet the target levels, controller 130 adjusts one or more of the operating parameters. After such adjustment, the output response is again measured and compared sequentially as above until target levels are reached. The performance characteristics and measured output response can be added to the database if desired, to provide more precise information to controller 130.

Accordingly, using the above method and system, highly efficient, low emissions and reliable operation of a gas turbine at part-load, turndown conditions can be readily achieved. Gas turbines using such methods and systems need not be re-tuned for seasonal variations in temperature and humidity and the like. Further, the controller of the gas turbine can determine, in a somewhat automated fashion, optimal operational parameters in such part-load or turndown conditions. Historical data can be added to the database on the fly for later querying by the controller, thereby continuously fine tuning the database for even further improved operation.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

We claim:

1. A method of operating a gas turbine at a reduced load, the method comprising:
operating a gas turbine at multiple sets of operational parameters;
measuring at least one output response of the gas turbine at each of the sets of operational parameters;
creating a database at least partially including correlations of each of the sets of operational parameters with the measured output response;
determining a desired reduced gas turbine load;
selecting a set of operational parameters from the database that provides the desired reduced gas turbine load and that meets a target level for the output response; and
further operating the gas turbine at the selected set of operational parameters.

2. The method of claim 1, further including the steps of:
measuring the output response during the further operation of the gas turbine;
comparing the measured output response to the target level for the output response; and
selecting an alternate set of operational parameters if the measured output response does not meet the target level.

3. The method of claim 2, further including, after the selecting an alternate set of operational parameters step, repeating the further operating step and the steps thereafter.

4. The method of claim 1, wherein the set of operational parameters includes one or more of the level of an inlet guide vane angle, an inlet bleed heat, a combustor fuel split, and a control curve.

5. The method of claim 1, wherein the output response includes one or more of a level of emissions, lean blowout, and combustor instability.

6. The method of claim 1, wherein the creating step includes generating partial derivatives relating the operational parameters to the measured output response.

7. The method of claim 1, further including adding to the database the measured output response at the set of operational parameters.

8. A method of operating a gas turbine at a reduced load, the method comprising:
determining a desired reduced gas turbine load;
consulting a database including multiple sets of operational parameters correlated with at least one measured output response at each set of operational parameters;
selecting a set of operational parameters from the database that corresponds to the reduced gas turbine load and that meets a target level for the output response; and
operating the gas turbine at the selected set of operational parameters.

9. The method of claim 8, further including the steps of:
measuring the output response during the operation of the gas turbine;
comparing the measured output response to the target level for the output response; and
selecting an alternate set of operational parameters if the measured output response does not meet the target level.

10. The method of claim 9, further including, after the selecting an alternate set of operational parameters step, repeating the operating step and the steps thereafter.

11. The method of claim 8, wherein the set of operational parameters includes one or more of the level of an inlet guide vane angle, an inlet bleed heat, a combustor fuel split, and a control curve.

12. The method of claim 8, wherein the output response includes one or more of a level of emissions, lean blowout, and combustor instability.

13. The method of claim 8, further including adding to the database the measured output response at the set of operational parameters.

14. The method of claim 8, wherein the database is created at least partially via operation of the gas turbine.

15. The method of claim 8, wherein the database is created at least partially via modeling.

16. A gas turbine including:
a compressor section;
a combustion section downstream from the compressor section;
a turbine section downstream from the combustion section; and
a controller for controlling the operation of the gas turbine at a reduced load, the controller capable of querying a database including multiple sets of operational parameters for the gas turbine correlated with at least one measured output response at each set of operational parameters, one of the sets of operational parameters providing a desired gas turbine load and that meets a target level for the output response.

17. The gas turbine of claim 16, wherein the set of operational parameters includes one or more of the level of an inlet guide vane angle, an inlet bleed heat, a combustor fuel split, and a control curve.

18. The gas turbine of claim 16, wherein the output response includes one or more of a level of emissions, lean blowout, and combustor instability.

19. The gas turbine of claim 16, further including at least one sensor in communication with the controller for sensing at least one output response.

20. The gas turbine of claim 19, wherein the controller adds to the database the sensed output response correlated with the set of operational parameters.

21. The gas turbine of claim 16, wherein the measured output responses are determined at least partially via operation of the gas turbine.

22. The gas turbine of claim 16, wherein the measured output responses are determined at least partially via modeling.
